(19) United States
(12) Patent Application Publication
(10) Pub. No.: US 2025/0370237 A1
(43) Pub. Date: Dec. 4, 2025

(54) OPTICAL STRUCTURE AND DISPLAY APPARATUS

(71) Applicants: Beijing Zitiao Network Technology Co., Ltd., Beijing (CN); Lemon Inc., Grand Cayman (KY)

(72) Inventors: Shaopeng ZHU, Beijing (CN); Ziyang ZHANG, Los Angeles, CA (US); Xuan ZHONG, Beijing (CN); Hanning YANG, Beijing (CN); Ling FU, Beijing (CN); Jian CHEN, Beijing (CN)

(21) Appl. No.: 19/075,236

(22) Filed: Mar. 10, 2025

(30) Foreign Application Priority Data
Jun. 3, 2024 (CN) 202410711743.3

(51) Int. Cl. G02B 17/08

(52) U.S. Cl. CPC G02B 17/0856

(57) ABSTRACT

An optical structure and a display apparatus. The optical structure includes a lens structure, a beam splitting film, a reflective polarizing film, a phase retardation film and a compensation film. The lens structure includes a first surface and a second surface, the phase retardation film and the compensation film are arranged between the beam splitting film and the reflective polarizing film, the compensation film includes at least one sub-compensation film, the sub-compensation film includes a plurality of protruding structures spaced apart, a refractive index in a thickness direction of the compensation film is nz, the maximum in-plane refractive index and the minimum in-plane refractive index of the compensation film are nx and ny, respectively, and a thickness of the compensation film is d, nz, nx, ny, and d satisfy a following relational equation: nz>nx, nz>ny, (nx−ny)*d≤20 nm.

### CROSS REFERENCE

The present application claims priority of Chinese Patent Application No. 202410711743.3, filed on Jun. 3, 2024, the disclosure of which is incorporated herein by reference in its entirety as part of the present application.

### TECHNICAL FIELD

Embodiments of the present disclosure relate to an optical structure and a display apparatus.

### BACKGROUND

In virtual reality (VR) and mixed reality (MR) devices, a near-eye display device magnifies an image displayed by a display screen through a lens to make people feel immersive.

The combination of a display screen and a lens is known as an opto-mechanical module, and the existing opto-mechanical module includes a combination of a liquid crystal display (LCD) screen or a silicon-based organic light-emitting diode (OLED) screen with a folded optical-path lens (i.e., a pancake), and the opto-mechanical module regulates polarized light through a special polarized optical assembly to achieve an effect of lightness and thinness.

### SUMMARY

Embodiments of the present disclosure provides an optical structure and a display apparatus.

Embodiments of the present disclosure provides an optical structure, having a light incident side and a light-exiting side, including: a lens structure, including a first surface and a second surface arranged opposite to each other, wherein the first surface is a surface of the lens structure on the light incident side; a beam splitting film, arranged on a side, away from the second surface, of the first surface; a reflective polarizing film, arranged on a side, away from the first surface, of the second surface; a phase retardation film, arranged between the beam splitting film and the reflective polarizing film; and a compensation film, arranged between the beam splitting film and the reflective polarizing film, wherein the compensation film includes at least one sub-compensation film, and each of the at least one sub-compensation film includes a plurality of protruding structures spaced apart, a refractive index of the compensation film in a thickness direction is nz, the compensation film has a maximum in-plane refractive index and a minimum in-plane refractive index in a plane parallel to a surface of the compensation film, the maximum in-plane refractive index and the minimum in-plane refractive index are nx and ny, respectively, and a thickness of the compensation film is d, and nz, nx, ny, and d satisfy a following relational equation: nz>nx, nz>ny; (nx−ny)*d≤20 nm.

For example, in the optical structure according to embodiments of the present disclosure, wherein the at least one sub-compensation film includes one sub-compensation film, within a section, parallel to a setting surface, of the one sub-compensation film, a total length of protruding structures of the plurality of protruding structures of the one sub-compensation film through which one same reference line passes is L1, and a length of the same reference line between two points where the same reference line intersects an outer contour of the one sub-compensation film is L2, and a ratio of L1 to L2 is a filling rate of the protruding structures of the plurality of protruding structures through which the reference line passes, the setting surface is a surface of the lens structure or a surface of a film material on which the one sub-compensation film is located, and an orthographic projection of the reference line on a plane vertical to an optical axis of the lens structure is a straight line, and within the section, an absolute value of a difference of the filling rates of the protruding structures through which different reference lines pass is not greater than 30%.

For example, in the optical structure according to embodiments of the present disclosure, wherein an average value of included angles between the plurality of protruding structures and the setting surface is in a range of 80 degrees to 90 degrees.

For example, in the optical structure according to embodiments of the present disclosure, wherein within the section, a length of a line segment passing through a sectional centre of the protruding structure of the plurality of protruding structures and intersecting with a sectional contour of the protruding structure of the plurality of protruding structures is a sectional dimension, the protruding structure of the plurality of protruding structures has a maximum sectional dimension and a minimum sectional dimension, and a ratio of the maximum sectional dimension to the minimum sectional dimension is not greater than 5.

For example, in the optical structure according to embodiments of the present disclosure, a ratio of refractive indices of the one sub-compensation film in directions of the different reference lines is in a range of 0.7 to 1.3.

For example, in the optical structure according to embodiments of the present disclosure, wherein the at least one sub-compensation film includes a plurality of sub-compensation films arranged in a stacking manner, each of the plurality of sub-compensation films has a maximum in-plane refractive index and a minimum in-plane refractive index in a plane parallel to a surface thereof, the maximum in-plane refractive indices of the plurality of sub-compensation films are all equal, the minimum in-plane refractive indices of the plurality of sub-compensation films are all equal, and a direction where the maximum in-plane refractive index of each of the plurality of sub-compensation films lies is a maximum in-plane refractive index direction, and the plurality of sub-compensation films include N sub-compensation films whose maximum in-plane refractive index directions are all different, and an included angle between the maximum in-plane refractive index directions of different sub-compensation films in the N sub-compensation films is substantially an integer multiple of 360 degrees/2N, and the included angle is not greater than 90 degrees.

For example, in the optical structure according to embodiments of the present disclosure, wherein within a section, parallel to a setting surface, of each sub-compensation film of the N sub-compensation films, a total length of protruding structures of the plurality of protruding structures of the sub-compensation film of the N sub-compensation films through which one same reference line passes is L1, and a length of the same reference line between two points where the same reference line intersects an outer contour of the sub-compensation film of the N sub-compensation films is L2, and a ratio of L1 to L2 is a filling rate of the protruding structures of the plurality of protruding structures through which the reference line passes, the setting surface is a surface of the lens structure or a surface of a film material on which the sub-compensation film of the N sub-compensation films is located, and an orthographic projection of the reference line on a plane vertical to an optical axis of the lens structure is a straight line, and within the section, the filling rate of the protruding structures of the plurality of protruding structures through which the reference line extending along the maximum in-plane refractive index direction passes is greater than the filling rate of the protruding structures of the plurality of protruding structures through which the reference line extending in other directions passes.

For example, in the optical structure according to embodiments of the present disclosure, wherein the plurality of protruding structures of each of the N sub-compensation films is arranged on the setting surface in an inclined manner.

For example, in the optical structure according to embodiments of the present disclosure, wherein in the thickness direction of the sub-compensation film, dimensions of the plurality of protruding structures are in a range of 100 nm to 5 μm, and a ratio of the dimensions of different protruding structures of the plurality of protruding structures in the thickness direction is in a range of 0.8 to 1.2; and within a section, parallel to the setting surface, of the sub-compensation film of the at least one sub-compensation film, a length of a line segment passing through a sectional centre of the protruding structure of the plurality of protruding structures and intersecting with an sectional contour of the protruding structure of the plurality of protruding structures is a sectional dimension, the sectional dimension is in a range of 5 nm to 200 nm, and the setting surface is a surface of the lens structure or a surface of a film material on which the sub-compensation film of the at least one sub-compensation film is located.

For example, in the optical structure according to embodiments of the present disclosure, wherein the lens structure includes at least one lens, the at least one lens includes a compensation attached lens that is closest to the compensation film, the phase retardation film is arranged on a side, away from the compensation attached lens, of the compensation film, an average refractive index of the compensation film is n1, an average refractive index of the phase retardation film is n2, an average refractive index of the compensation attached lens is n3, and n2≥n1>n3.

For example, in the optical structure according to embodiments of the present disclosure, a phase retardation Rth in the thickness direction of the compensation film satisfies a following formula: Rth=[(nx+ny)/2−nz]*d, and the phase retardation Rth in the thickness direction of the compensation film is in a range of −20 nm to −130 nm.

For example, in the optical structure according to embodiments of the present disclosure, wherein the lens structure includes at least one lens, the compensation film is arranged on a surface of the lens, the phase retardation film is arranged on a surface, away from the lens, of the compensation film, and the surface of the lens is a setting surface.

For example, in the optical structure according to embodiments of the present disclosure, wherein the second surface includes at least one of the group consisting of a plane surface and a curved surface.

For example, in the optical structure according to embodiments of the present disclosure, wherein a material of the compensation film includes at least one of the group consisting of titanium dioxide, zirconium dioxide, aluminum oxide, niobium pentoxide, tantalum pentoxide, cerium dioxide, hafnium dioxide, magnesium oxide, zinc oxide, silicon dioxide, silicon monoxide, yttrium trioxide, yttrium trifluoride, lanthanum trifluoride, magnesium difluoride, silicon nitride, zinc sulfide, lanthanum titanate, acrylic resin, polyolefin, polysiloxane, and polycarbonate.

For example, in the optical structure according to embodiments of the present disclosure, For example, the sub-compensation film further includes a filling medium arranged between the plurality of protruding structures 1510 spaced apart, and a refractive index of the filling medium is less than a refractive index of a material of the protruding structure of the plurality of protruding structures.

For example, in the optical structure according to embodiments of the present disclosure, further including: a linear polarizing film, arranged on a side, away from the lens structure, of the reflective polarizing film; and an anti-reflective film, arranged on a side, away from the lens structure, of the linear polarizing film.

For example, in the optical structure according to embodiments of the present disclosure, including a display screen and the optical structure described in any one of the above, wherein the display screen is arranged on the light incident side of the optical structure.

### BRIEF DESCRIPTION OF DRAWINGS

In order to clearly illustrate the technical solutions of the embodiments of the present disclosure, the drawings of the embodiments will be briefly described in the following; it is obvious that the described drawings are only related to some embodiments of the present disclosure and thus are not limitative to the present disclosure.

FIG. 1 is a structural schematic diagram of an opto-mechanical module;

FIG. 2 is a schematic diagram of a section of an optical structure provided in embodiments of the present disclosure;

FIG. 3 is an enlarged schematic diagram of a local region A of a compensation film illustrated by FIG. 2;

FIG. 4 is a schematic diagram of a section P1 of a compensation film illustrated by FIG. 3;

FIG. 5 is an enlarged schematic diagram of a local region A of another type of compensation film illustrated by FIG. 2;

FIG. 6 is an equivalent schematic diagram of maximum in-plane refractive index directions of a plurality of sub-compensation films of a compensation film provided in embodiments of the present disclosure;

FIG. 7 is a structural schematic diagram of a local region B of a sub-compensation film of FIG. 5;

FIG. 8 is an enlarged schematic diagram of a local region A of still another compensation film illustrated by FIG. 2; and

FIG. 9 is a schematic diagram of a section of a display apparatus provided in embodiments of the present disclosure.

### DETAILED DESCRIPTION

In order to make the objectives, technical solutions, and advantages of the embodiments of the present disclosure clearer, the technical solutions of the embodiments of the present disclosure will be clearly and completely described below in conjunction with the accompanying drawings of the embodiments of the present disclosure. It is apparent that the described embodiments are part of the embodiments of the present disclosure, not all of the embodiments. Based on the described embodiments of the present disclosure, all other embodiments obtained by those skilled in the art without creative labor are within the scope of protection of the present disclosure.

Unless otherwise defined, technical terms or scientific terms used in this disclosure shall have the usual meaning understood by those of ordinary skill in the art to which this disclosure belongs. The use of the words “first”, “second”, and similar words in this disclosure does not indicate any order, quantity, or importance, but is only used to distinguish different components. The words “including” or “comprising” and similar words mean that the elements or objects appearing before the word cover the elements or objects listed after the word and their equivalents, without excluding other elements or objects. The words “connected” or “connecting” and similar words are not limited to physical or mechanical connections, but can include electrical connections, whether direct or indirect.

Unless otherwise defined, the features of “parallel”, “vertical” and “identical” used in the embodiments of the present disclosure include the strict sense of “parallel”, “vertical” and “identical”, as well as the situations involving certain errors such as “substantially parallel”, “substantially vertical” and “substantially identical”. For example, the above-mentioned “substantially” can indicate that the difference value of the compared object is within 10% or 5% of the average value of the compared object. When the number of a component or element is not specifically indicated in the following embodiments of the present disclosure, it means that the component or element can be one or more, or can be understood as at least one. “At least one” refers to one or more, and “more than one” refers to at least two. The “arranged in the same layer” in the embodiments of the present disclosure refers to the relationship between multiple film layers formed by the same material after the same step (e.g., a one-step patterning process). Here, “in the same layer” does not always refer to the thickness of multiple film layers being the same or the height of multiple film layers being the same in the cross-sectional view.

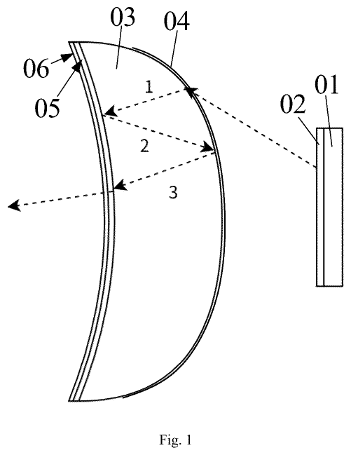

FIG. 1 is a structural schematic diagram of an opto-mechanical module. As illustrated by FIG. 1, the opto-mechanical module includes a silicon-based OLED screen 01 and an optical assembly. A circularly polarized polarizing composite film 02 is arranged on a side, adjacent to an optical assembly, of the silicon-based OLED screen 01, the silicon-based OLED screen 01 is configured to generate an image, and the screen 01 emits non-polarized light without any processing, the circularly polarized polarizing composite film 02 includes at least a linear polarizing film and quarter-phase retardation films located on two sides of the linear polarizing film, respectively, the circularly polarized polarizing composite film 02 is attached to the surface of the silicon-based OLED screen 01, the linear polarizing film converts the light emitted by the silicon-based OLED screen 01 into linearly polarized light, and then the quarter-phase retardation film away from the screen 01 converts the linearly polarized light into circularly polarized light after the linearly polarized light passes through the quarter-phase retardation film away from the screen 01, while the quarter-phase retardation film adjacent to the screen 01 mainly plays a role of eliminating reflections from a metal cathode within the silicon-based OLED screen 01.

As illustrated by FIG. 1, the optical assembly includes a lens 03, a beam splitting film 04, a quarter-phase retardation film 05, and a reflective polarizing film 06. The lens 03 is configured to form an optical focus and magnify an image, the beam splitting film 04 provides a reflective surface of a folded optical path, the quarter-phase retardation film 05 functions to change a polarizated state of light, such that circularly polarized light is changed to linearly polarized light, or the linearly polarized light is changed to the circularly polarized light, and the reflective polarizing film 06 provides another reflective surface of the folded optical path, and functions to transmit polarized light in one direction (e.g., S light) and reflect polarized light in another direction (e.g., P light).

In the above opto-machine module, the key to the formation of the folded optical path lies in interconversion between the circularly polarized light and the linearly polarized light, while the ellipticity of the circularly polarized light within the folded optical path is an important physical quantity that determines optical properties of the folded optical path. The ellipticity of 1 represents that the polarized light is fully circularly polarized light, the ellipticity of 0 represents that the polarized light is fully linearly polarized light, and the ellipticity between 0 and 1 represents that the polarized light is elliptically polarized light, and the closer the ellipticity is to 1, the closer the polarized light is to the circularly polarized light. The above opto-machine module requires that it is better when the ellipticity of the circularly polarized light in the folded optical path (such as optical paths 1, 2, and 3 illustrated by FIG. 1) is as close to I as possible, and if the ellipticity is low, a portion of light does not follow the design of the optical path and forms stray light or ghosting, which affect the imaging quality.

The quarter-phase retardation film is a key optical film layer for interconversion between the linearly polarized light and the circularly polarized light. However, due to limitations of general materials, a wavelength and an incident angle of the incident light have a greater influence on the phase retardation of the quarter-phase retardation film, therefore, the quarter-phase retardation film has difficulty in converting the linearly polarized light with different wavelengths or different incident angles into near-circularly polarized light with the ellipticity close to 1.

The influence of the wavelength and incident angle of the incident light on the phase retardation of the quarter-phase retardation film may be compensated by using a positive C film. The quarter-phase retardation film adopts birefringent materials with different refractive indices in different directions. Suppose that the quarter-phase retardation film has a maximum in-plane refractive index and a minimum in-plane refractive index in a plane parallel to the surface of the quarter-phase retardation film, the maximum in-plane refractive index is n01, the minimum in-plane refractive index is n02, the direction of the maximum in-plane refractive index is vertical to the direction of the minimum in-plane refractive index, the refractive index in the thickness direction of the quarter-phase retardation film is n03, the thickness of the quarter-phase retardation film is d01, then the phase retardation in the thickness direction of the quarter-phase retardation film satisfies the following formula: Rth=[(n01+n02)/2−n03]*d01, and the in-plane phase retardation is R0=(n01−n02)*d. When Rth is equal to 0, the in-plane phase retardation R0 of the quarter-phase retardation film does not change along with the change in the incident angle of the incident light, however, general quarter-phase retardation films cannot have the phase retardation Rth of 0, and general quarter-phase retardation films have a positive phase retardation Rth, such that the in-plane phase retardation of the quarter-phase retardation film changes along with the change in the incident angle of the incident light. For example, after a linearly polarized light with a relatively large incident angle passes through the quarter-phase retardation film, the linearly polarized light can be converted into elliptically polarized light with a relatively low ellipticity, and after the incident light with different incident angles passes through the quarter-phase retardation film, the ellipticities of the converted elliptically polarized light are different, thereby influencing optical properties and imaging uniformity of the folded optical path of the opto-mechanical module. In addition, in some opto-mechanical modules, other optical film materials or optical components may also be located within the folded optical path, and these optical film materials or optical components may also have phase retardations in the thickness direction, and in order to reduce the influence on the ellipticity of the circularly polarized light, the phase retardation in the thickness direction of these optical film materials or optical components also needs to be compensated. For example, the optical component includes an element or a material having anti-reflective properties, birefringence properties, and phase retardation properties.

The positive C film is generally adopted to compensate the phase retardation in the thickness direction of the quarter-phase retardation film and other optical film materials or optical components. The positive C film has a negative phase retardation in its thickness direction and has an in-plane phase retardation of basically 0, i.e., the positive C film satisfies a formula of n06>n04=n05, where n04 is the maximum in-plane refractive index of the positive C film, n05 is the minimum in-plane refractive index, and n06 is the refractive index in the thickness direction of the positive C film. The general positive C film is aligned of rod-shaped liquid crystals, and a long edge of the aligned rod-shaped liquid crystal is along the thickness direction of the positive C film, and the phase retardation in the thickness direction of the quarter-phase retardation film that may be effectively compensated by the positive C film may be in a range of 70 nm to 150 nm.

However, the positive C film has the following drawbacks: 1) the types of liquid crystal raw materials used to form the positive C film are very limited, and the refractive indices of the selected liquid crystals are relatively high. Since the refractive index in each direction of the positive C film mainly depends on the liquid crystal molecules themselves, and merely very limited types of liquid crystal molecules are suitable for forming the positive C film, therefore, the refractive index of the positive C film has very few choices and is usually high and is significantly higher than the refractive indices of general quarter-phase retardation films and lens, thereby resulting in serious reflections on an interface between the positive C film and the quarter-phase retardation films, the lens, other optical film materials or other optical components, easily leading to formation of stray light and ghosting, and influencing the imaging quality. For example, the material of the quarter-phase retardation film 05 in FIG. 1 is liquid crystal with the average refractive index of 1.56, the material of the lens 03 is cyclic olefin copolymer (COC) resin with the refractive index of 1.54, and the refractive index of the positive C film formed by a liquid crystal coating process is 1.8, thereby resulting in serious reflections on the interface between the positive C film and the quarter-phase retardation film and on the interface between the positive C film and the lens. 2) The phase retardation in the thickness direction of the positive C film is difficult to set, and the relatively low phase retardation in the thickness direction is difficult to stably obtain. The positive C film is usually formed by the solution with liquid crystal molecules through a roll-to-roll precision coating process. Through such a process, the phase retardation in the thickness direction of the positive C film is difficult to set, and the phase retardation in the thickness direction of the general positive C film has only a few specific values, however, when the phase retardation in the thickness direction of a plurality of optical film materials or optical components of the opto-mechanical module needs to be compensated, general positive C films may not flexibly set and compensate. In addition, the reduction of a coating thickness of the positive C film also leads to a reduction of stability and uniformity of the positive C film, therefore, an absolute value of the phase retardation in the thickness direction of the positive C film is difficult to be consistently small. For example, the absolute value is difficult to be less than 70 nm. For example, the phase retardation in the thickness direction of the quarter-phase retardation film 05 in FIG. 1 is 60 nm, and the phase retardation in the thickness direction of the corresponding positive C film needs to be −60 nm, and this phase retardation requires a relatively small thickness of the coated liquid crystal, for example, the thickness is 1 μm, and with such a small thickness, devices manufactured through a roll-to-roll precision coating process have difficulty in ensuring uniformity of thickness and are lower in mass production. (3) The positive C film is a liquid crystal polymer film layer, is hard and brittle, and is easy to break under an external force, and when the positive C film is attached to the surface of a curved lens, the challenge of the attachment process is relatively high, and defective products are easily produced.

Embodiments of the present disclosure provide an optical structure and a display apparatus. The optical structure has a light incident side and a light-exiting side, and the optical structure includes a lens structure, a beam splitting film, a reflective polarizing film, a phase retardation film, and a compensation film. The lens structure includes a first surface and a second surface arranged opposite to each other, and the first surface is a surface of the lens structure on the light incident side; the beam splitting film is arranged on a side, away from the second surface, of the first surface, the reflective polarizing film is arranged on a side, away from the first surface, of the second surface, the phase retardation film is arranged between the beam splitting film and the reflective polarizing film, the compensation film is arranged between the beam splitting film and the reflective polarizing film, the compensation film includes at least one sub-compensation film, the sub-compensation film includes a plurality of protruding structures spaced apart, a refractive index in a thickness direction of the compensation film is nz, the compensation film has a maximum in-plane refractive index and a minimum in-plane refractive index in a plane parallel to a surface of the compensation film, the maximum in-plane refractive index and the minimum in-plane refractive index are nx and ny, respectively, and a thickness of the compensation film is d, nz, nx, ny, and d satisfy a following relational equation: nz>nx, nz>ny, (nx−ny)*d≤20 nm. For example, the maximum in-plane refractive index nx and the minimum in-plane refractive index ny may be approximately equal.

In the present disclosure, the refractive index in the thickness direction of the compensation film is a maximum value of the refractive indices of the compensation film in each direction; within the plane parallel to the surface of the compensation film, the compensation film has the maximum refractive index and the minimum refractive index, e.g., within the plane, the compensation film has different in-plane refractive indices along different directions, the maximum refractive index in the plane is the maximum in-plane refractive index, and the minimum refractive index in the plane is the minimum in-plane refractive index; e.g., within the plane, the compensation film has the same in-plane refractive index along different directions, and the maximum in-plane refractive index is equal to the minimum in-plane refractive index. For example, the surface of the compensation film may be a plane or a curved surface. For example, a normal direction of the surface of the compensation film is a thickness direction of the compensation film.

In the optical structure provided in embodiments of the present disclosure, the sub-compensation film of the compensation film includes a plurality of protruding structures spaced apart, such that the in-plane refractive index of the compensation film is less than the refractive index in the thickness direction.

According to a formula for calculating the phase retardation in the thickness direction of the compensation film, Rth=[(nx+ny)/2−nz]*d, the phase retardation Rth in the thickness direction of the compensation film is a negative value, and the compensation film can be used to compensate the optical film layer or the optical component which has a positive phase retardation in the thickness direction, therefore, the compensation film can improve the ellipticity of the circularly polarized light within the folded optical path of the optical structure and improve the imaging quality. Moreover, the in-plane phase retardation R0 of the compensation film satisfies the formula of R0=(nx−ny)*d, and R0 is not greater than 20 nm, i.e., the compensation film has a very small in-plane phase retardation, and has a small influence on the imaging quality. For example, when the maximum in-plane refractive index nx and the minimum in-plane refractive index ny of the compensation film are approximately equal, the in-plane phase retardation R0 of the compensation film is approximately zero.

By changing a spacing between the plurality of protruding structures of the compensation film, the in-plane refractive index of the compensation film can be changed, and then the phase retardation Rth in the thickness direction of the compensation film can be further changed, therefore, the phase retardation Rth in the thickness direction of the compensation film can be set. By changing the spacing between the plurality of protruding structures, the different phase retardations Rth in the thickness direction can be obtained, thereby flexibly and more conveniently setting the phase retardation Rth in the thickness direction of the compensation film. As a result, the compensation film can more flexibly and favorably compensate the phase retardation in the thickness direction of different optical film layers or optical components of the optical structure.

The refractive index nz in the thickness direction of the compensation film is related to a material of the compensation film, and by selecting different materials, compensation films with different refractive indices nz can be obtained, such that compensation films with more ranges of values of the refractive indices nz ca be obtained more flexibly and conveniently. For example, an average refractive index of the compensation film is n1, the average refractive indices of two optical elements adjacent to the compensation film are na and nb, and the average refractive index may be approximated as an average value of the in-plane refractive index and the refractive index in the thickness direction, therefore, the average refractive index n1 of the compensation film can be made between the average refractive index na and the average refractive index nb, reflection between the compensation film and the two adjacent optical elements is reduced, and the imaging quality is improved. The two optical elements may be lenses or film materials, for example, the film materials include, but are not limited to, the reflective polarizing film, the phase retardation film, the optical adhesive or an anti-reflective film.

In addition, compared with liquid crystal polymers, the compensation film has superior mechanical properties, and can be directly formed on a surface of the lens structure or on a surface of the film material, thereby improving production efficiency and yield rate of the optical structure.

Hereinafter, the optical structure and the display apparatus provided in embodiments of the present disclosure are described in detail in combination with the accompanying drawings.

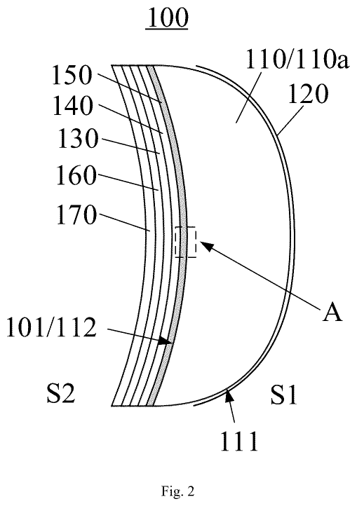

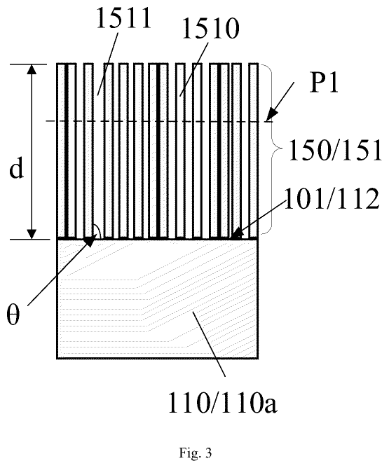

Embodiments of the present disclosure provide an optical structure. FIG. 2 is a schematic diagram of a section of an optical structure provided in embodiments of the present disclosure; and FIG. 3 is an enlarged schematic diagram of a local region A of a compensation film illustrated by FIG. 2. As illustrated by FIG. 2 and FIG. 3, the optical structure 100 has a light incident side S1 and a light-exiting side S2, and the optical structure 100 includes a lens structure 110, a beam splitting film 120, a reflective polarizing film 130, a phase retardation film 140, and a compensation film 150. The lens structure 110 includes a first surface 111 and a second surface 112 arranged opposite to each other, and the first surface 111 is a surface of the lens structure on the light incident side S1; the beam splitting film 120 is arranged on a side, away from the second surface 112, of the first surface 111, the reflective polarizing film 130 is arranged on a side, away from the first surface 111, of the second surface 112, the phase retardation film 140 is arranged between the beam splitting film 120 and the reflective polarizing film 130, the compensation film 150 is arranged between the beam splitting film 120 and the reflective polarizing film 130, the compensation film 150 includes at least one sub-compensation film 151, the sub-compensation film 151 includes a plurality of protruding structures 1510 spaced apart, a refractive index in a thickness direction of the compensation film 150 is nz, the compensation film 150 has a maximum in-plane refractive index and a minimum in-plane refractive index in a plane parallel to a surface of the compensation film, the maximum in-plane refractive index and the minimum in-plane refractive index are nx and ny, respectively, and a thickness of the compensation film 150 is d. nz, nx, ny and d satisfy a following relational equation: nz>nx, nz>ny, (nx−ny)*d≤20 nm.

In the optical structure provided in the embodiments of the present disclosure, the sub-compensation film of the compensation film includes the plurality of protruding structures spaced apart, such that the in-plane refractive index of the compensation film is less than the refractive index in the thickness direction. According to the formula for calculating the phase retardation in the thickness direction of the compensation film: Rth=[(nx+ny)/2−nz]*d, the phase retardation Rth in the thickness direction of the compensation film is a negative value, and the compensation film can be used to compensate the optical film layer or the optical component which has a positive phase retardation in the thickness direction, therefore, the compensation film can improve the ellipticity of the circularly polarized light within the folded optical path of the optical structure and improve the imaging quality. Moreover, the in-plane phase retardation R0 of the compensation film satisfies the formula of R0−(nx−ny)*d, and R0 is not greater than 20 nm, i.e., the compensation film has a very small in-plane phase retardation, and has a small influence on the imaging quality. For example, the in-plane phase retardation R0 of the compensation film may be zero, at this time, the maximum in-plane refractive index nx and the minimum in-plane refractive index ny of the compensation film are equal.

A type, number, or position within the optical structure of the optical film layer or optical component compensated by the compensation film is not specifically limited in the embodiments of the present disclosure. For example, the compensation film may compensate at least one optical film layer or optical component arranged between the beam splitting film and the reflective polarizing film. For example, the compensation film may compensate the phase retardation film arranged between the beam splitting film and the reflective polarizing film. For example, the compensation film may compensate a plurality of optical film layers or a stack layer of optical components arranged between the beam splitting film and the reflective polarizing film, the plurality of optical film layers or optical components include at least the phase retardation film. The optical component in the present disclosure refers to various elements or materials that control or change light, for example, the optical component includes the element or material having anti-reflective properties, birefringence properties and phase retardation properties, including, but is not limited to, the optical adhesive, the film, or the lens.

By changing a spacing between the plurality of protruding structures of the compensation film, the in-plane refractive index of the compensation film can be changed, and then the phase retardation Rth in the thickness direction of the compensation film can be further changed, therefore, the phase retardation Rth in the thickness direction of the compensation film can be set. By changing the spacing between the plurality of protruding structures, the different phase retardations Rth in the thickness direction can be obtained, thereby more flexibly and conveniently setting the phase retardation Rth in the thickness direction of the compensation film. As a result, the compensation film can more flexibly and favorably compensate the phase retardation in the thickness direction of different optical film layers or optical components of the optical structure.

The refractive index nz in the thickness direction of the compensation film is related to a material of the compensation film, and by selecting different materials, the compensation films with different refractive indices nz can be obtained, such that the compensation films with more ranges of values of the refractive indices nz can be obtained more flexibly and conveniently. For example, an average refractive index of the compensation film is n1, the average refractive indices of two optical elements adjacent to the compensation film are na and nb, and the average refractive index may be approximated as the average value of the in-plane refractive index and the refractive index in the thickness direction, therefore, the average refractive index n1 of the compensation film can be made between the average refractive index na and the average refractive index nb, the reflection between the compensation film and the two adjacent optical elements can be reduced, and the imaging quality is improved. The two optical elements may be lenses or film materials, for example, the film materials include, but are not limited to, the reflective polarizing film, the phase retardation film, the optical adhesive or an anti-reflective film.

In addition, compared with liquid crystal polymers, the compensation film has superior mechanical properties, and can be directly formed on a surface of the lens structure or on a surface of the film material, thereby improving production efficiency and yield rate of the optical structure.

It should be noted that, FIG. 2 schematically illustrates the lens structure 110 includes one lens 110a, and the first surface 111 and the second surface 112 are two surfaces of the lens 110a which are arranged opposite to each other. However, this is not limited in the embodiments of the present disclosure. The lens structure may also include a plurality of lenses, and the first surface and the second surface may be two surfaces of a same lens in the plurality of lenses, or may be surfaces on different lenses. For example, when the lens structure includes the plurality of lenses, two lenses may be arranged between the reflective polarizing film and the beam splitting film, e.g., the reflective polarizing film and the beam splitting film are located on different lenses, respectively. For example, when the lens structure includes the plurality of lenses, the plurality of lenses may be spaced apart from each other or may be bonded together by means of the optical adhesive.

FIG. 3 schematically illustrates a partially enlarged schematic diagram of FIG. 2 at position A and only illustrates a structure of the compensation film 150 without reference to a shape of a film layer. It may be understood that, the structure of the compensation film 150 at other positions is the same as that in FIG. 3. Referring to FIG. 3, the thickness d of the sub-compensation film 151 is a vertical distance from an end face, away from a setting surface 101, of the protruding structure 151 to the setting surface 101.

For example, the in-plane phase retardation R0 of the compensation film may be not greater than 10 nm. For example, the in-plane phase retardation R0 of the compensation film may be not greater than 5 nm. For example, the in-plane phase retardation R0 of the compensation film may be equal to 0, at this time, the refractive indices of all directions within the film of the compensation film are the same, and the compensation film exhibits uniaxial birefringent properties.

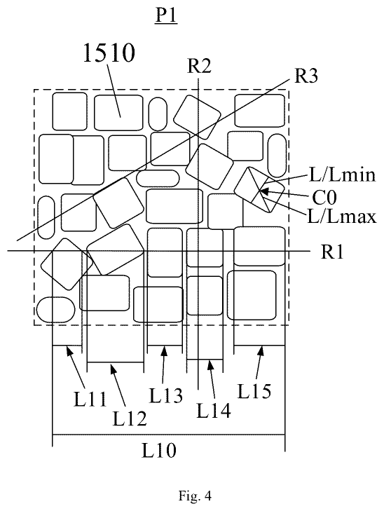

FIG. 4 is a schematic diagram of a section P1 of a compensation film illustrated by FIG. 3. As illustrated by FIG. 2 to FIG. 4, the compensation film 150 includes one sub-compensation film 151, within the section P1, parallel to the setting surface 101, of the sub-compensation film 151, a total length of the protruding structures 1510 of the sub-compensation film 151 through which one same reference line passes is L1, and a length of the same reference line between two points where the same reference line intersects an outer contour of the sub-compensation film 151 is L2, and a ratio of L1 to L2 is a filling rate of the protruding structures 1510 through which the reference line passes, the setting surface 101 is the surface of the lens structure or the surface of the film material on which the sub-compensation film 151 is located, and an orthographic projection of the reference line on a plane vertical to an optical axis of the lens structure 110 is a straight line. Within the section P1, an absolute value of a difference of the filling rates of the protruding structures 1510 through which different reference lines pass is not greater than 30%. It should be noted that, the reference line in the present disclosure is a virtual line, not actually an existing line, and the setting surface is an actually existing surface in the optical structure, and is the surface of the lens structure or the surface of the film material on which the sub-compensation film is located.

As illustrated by FIG. 2 and FIG. 3, the sub-compensation film 151 is arranged on the surface of the lens structure 110, specifically, on the second surface 112 of the lens 110a, and the setting surface 101 is the second surface 112, which are not limited in the embodiments of the present disclosure. The sub-compensation film may also be arranged on the surface of the film material, and the film material on which the sub-compensation film is located includes, but is not limited to, the reflective polarizing film and the phase retardation film. For example, when the reflective polarizing film and the phase retardation film include the optical adhesive or an anti-reflective film therebetween, the film material on which the sub-compensation film is located also includes the optical adhesive and the anti-reflective film, which is not repeated redundantly herein.

For example, as illustrated by FIG. 2, the second surface 112 is a curved surface, the setting surface 101 is a curved surface, and accordingly, the section P1 parallel to the setting surface 101 is also a curved surface. However, the setting surface may also be a plane surface, and accordingly, the section parallel to the setting surface is also a plane surface. For example, different reference lines may be lines intersecting with each other or lines parallel to each other. For example, when the setting surface is a plane surface, the section parallel to the setting surface is also a plane surface and the reference line is a straight line. For example, when the setting surface is a curved surface, the section parallel to the setting surface is also a curved surface, and the reference line is a curve located on the section, and the orthographic projection of the curve on the plane vertical to the optical axis of the lens structure is the straight line. For example, the section parallel to the setting surface of the sub-compensation film 151 is also not limited to the position illustrated by FIG. 4, but may be at other positions in the thickness direction of the protruding structure 1510 of the sub-compensation film 151.

For example, as illustrated by FIG. 2, a surface of the sub-compensation film 151 is parallel to the setting surface 101, and a surface on which the in-plane refractive index is located is parallel to the setting surface 101. FIG. 4 schematically shows three different reference lines R1, R2, and R3, and the reference line may also be other lines located on the section P1, which will not be repeated redundantly herein. For example, when the setting surface is a curved surface, the reference line is a curve located on the section, and the orthographic projection of the curve on the plane vertical to the optical axis of the lens structure is the straight line. For example, different reference lines may be lines intersecting with each other or lines parallel to each other. For example, the reference line is the straight line when the setting surface is a plane surface. For example, the section, parallel to the setting surface, of the sub-compensation film 151 is also not limited to the position illustrated by FIG. 4, but may be at other positions in the thickness direction of the protruding structure 1510 of the sub-compensation film 151.

As illustrated by FIG. 4, with the reference line R1 as an example, the length of the protruding structure 1510 through which the reference line R1 passes is illustrated schematically. As illustrated by FIG. 4, the reference line R1 passes through five protruding structures, and the lengths of the five protruding structures passed through are L11, L12, L13, L14, and L15, respectively, then the total length L10 of the five protruding structures through which the reference line R1 passes satisfies the following formula: L10=L11+L12+L13+L14+L15. It should be noted that, since FIG. 4 illustrates only a portion of the protruding structures of the sub-compensation film 151, the above is merely used to provide a schematic illustration of the lengths of the protruding structures through which the reference line passes.

In the present example, when the absolute value of the difference of the filling rates of the protruding structures 1510 through which different reference lines pass is not greater than 30%, the refractive indices in the directions of different reference lines may be similar, such that the in-plane phase retardation R0 of the compensation film can be not greater than 20 nm, and the influence of the in-plane phase retardation of the compensation film on imaging can be minimized as much as possible. For example, the absolute value of the difference of the filling rates may also be not greater than 20%. For example, the absolute value of the difference of the filling rates may also be not greater than 10%, and the absolute value of the difference of the filling rates may also be not greater than 5%. For example, the difference of the filling rates may be equal to 0, at this time, the refractive indices of the compensation film in all directions is the same and the in-plane phase retardation of the compensation film is 0.

In some examples, as illustrated by FIG. 2 to FIG. 4, when the absolute value of the difference of the filling rates of the protruding structures 1510 through which different reference lines pass is within a reasonable range, the ratio of the refractive indices in the directions of different reference lines of the sub-compensation film 151 of the compensation film 150 is in a range of 0.7 to 1.3. As a result, the in-plane phase retardation of the compensation film 150 is relatively small, and the influence of the in-plane phase retardation of the compensation film 150 on imaging is reduced as much as possible. For example, the ratio is in a range of 0.8 to 1.2. For example, the ratio is in a range of 0.9 to 1.1.

In some examples, as illustrated by FIG. 3, an average value of included angles θ between the plurality of protruding structures 1510 and the setting surface 101 is in a range of 80 degrees to 90 degrees. For example, when the setting surface is a curved surface, the included angle is an included angle between the protruding structures 1510 and a tangent plane of the setting surface at the protruding structures 1510. For example, as illustrated by FIG. 3, the included angle between the protruding structure 1510 and the setting surface 101 is an included angle between an outer surface of the protruding structure 1510 and the setting surface 101.

In the present example, when the average value of the included angles is in a range of 80 degrees to 90 degrees, the absolute value of the difference of the filling rates of the protruding structures through which different reference lines pass is made as small as possible, thereby resulting in a relatively small in-plane phase retardation of the compensation film.

In some examples, as illustrated by FIG. 3, the included angles θ between the plurality of protruding structures 1510 and the setting surface 101 are in a range of 80 degrees to 90 degrees. For example, the plurality of protruding structures 1510 are vertical to the setting surface 101.

For example, the included angles between the plurality of protruding structures and the setting surface are not the same. For example, the included angles between the plurality of protruding structures and the setting surface may be partially the same. For example, the plurality of protruding structures may be partially parallel. For example, the plurality of protruding structures may be arranged in parallel.

For example, as illustrated by FIG. 2 and FIG. 3, when the setting surface 101 is a curved surface, the plurality of protruding structures 1510 are vertical to the setting surface 101.

For example, as illustrated by FIG. 2 and FIG. 3, when the setting surface 101 is a concave surface and the plurality of protruding structures 1510 of the sub-compensation film 151 are vertical to the setting surface 101, the sub-compensation film 151 may be formed by a serial bideposition (SBD) method.

The process of a serial bideposition (SBD) method is generally as follows: the lens or film material on which the setting surface is located is placed in a vacuum coating machine, there is an included angle between a tangent plane of the position to be plated on the setting surface and a deposition direction of an evaporative coating source, and the plurality of protruding structures can be formed on the setting surface when the included angle oscillates periodically within a range. For example, the included angle may oscillate between-90 degrees and +90 degrees, and a maximum amplitude and an oscillation period of the included angle and a corresponding evaporation deposition rate period are adjusted, then the sub-compensation film with the plurality of protruding structures vertical to the setting surface can be obtained, which is of course not limited in the embodiments of the present disclosure, for example, the sub-compensation film may also be formed by a physical vapor deposition (PVD), chemical vapor deposition (CVD) or glancing-angle deposition (GLAD) method.

In some examples, as illustrated by FIG. 4, within the section P1, a length of a line segment passing through a sectional centre CO of the protruding structure 1510 and intersecting with a sectional contour of the protruding structure 1510 is a sectional dimension L, the protruding structure has a maximum sectional dimension Lmax and a minimum sectional dimension Lmin, and a ratio of the maximum sectional dimension Lmax to the minimum sectional dimension Lmin is not greater than 5. Therefore, a shape of the section of the protruding structure 1510 is more uniform, and the lengths of the protruding structures 1510 through which different reference lines pass are more approximate, such that the absolute value of the difference of the filling rates of the protruding structures 1510 through which different reference lines pass may be made as small as possible, thereby resulting in a relatively small in-plane phase retardation of the compensation film 150. For example, the ratio may be not greater than 4. For example, the ratio may be not greater than 3. For example, the ratio may be not greater than 2. For example, the ratio may be equal to 1.

In some examples, a material of the sub-compensation film is aluminum oxide (Al₂O₃) and the deposition method is electron beam evaporation deposition. The protruding structure of the sub-compensation film is a cylinder, and multiple protruding structure are vertical to the setting surface. The refractive index in the thickness direction of the sub-compensation film is n_{solid}, and by controlling deposition conditions, the refractive index n_{solid} in the thickness direction may be 1.6. The maximum in-plane refractive index and the minimum in-plane refractive index of the sub-compensation film are equal, and the in-plane refractive index of the sub-compensation film may be regarded as the refractive index of a mixture of solid aluminum oxide and air, and an equivalent refractive index n_{eff} of the mixture is obtained through the following formula:

$$\frac{{n}_{eff}^{2} - 1}{1 + 0.5 ( {n}_{eff}^{2} - 1 )} = p \frac{{n}_{solid}^{2}}{1 + 0.5 ( {n}_{solid}^{2} - 1 )}$$

p is a filling density, and in a section, parallel to the setting surface, of the sub-compensation film, the filling density is a ratio of an area occupied by the plurality of protruding structures to an area defined by an outer contour of the compensation film. For example, when p is 0.58, the refractive index n_{eff} in the thickness direction may be 1.56 according to the above calculating formula, and according to the formula for calculating the phase retardation Rth in the thickness direction, when the thickness d of the sub-compensation film is equal to 1.5 μm, Rth=−60 nm. Therefore, when the phase retardation in the thickness direction of the phase retardation film is 60 nm, the compensation film can be used to compensate the phase retardation film, therefore, the phase retardation of the incident light can not change along with the change of the incident angle. Of course, the embodiment of the present disclosure is not limited to this. For example, the shape of the section of the protruding structure may be varied, and the distribution of the plurality of protruding structures of the sub-compensation film may be varied. For example, by adjusting the process, the value of the filling density may be adjusted, or the thickness of the compensation film may be adjusted. Therefore, the phase retardation in the thickness direction of the compensation film may be set.

For example, by adjusting the process conditions, compensation films having different refractive indices ne and no may be obtained. For example, it is possible that ne=1.56 and no=1.53; or ne=1.64 and no=1.62; or ne=1.68 and no=1.59. The values of ne and no are not limited in the embodiments of the present disclosure. The value of ne does not exceed the refractive index 1.76 of the aluminum oxide crystal block material, and the value of no does not exceed the value of ne, which will not be repeated redundantly herein.

For example, for other materials, such as silicon dioxide (SiO₂), silicon monoxide (SiO), titanium dioxide (TiO₂), niobium pentoxide (Nb₂O₅), tantalum pentoxide (Ta₂O₅), zirconium dioxide (ZrO₂), and the like, compensation films having different refractive indices may also be obtained using the above method, so as to obtain the different phase retardations.

FIG. 5 is an enlarged schematic diagram of a local region A of another compensation film illustrated by FIG. 2. As illustrated by FIG. 2 and FIG. 5, the compensation film 150 includes a plurality of sub-compensation films 151 arranged in a stacking manner, and each sub-compensation film 151 has a maximum in-plane refractive index and a minimum in-plane refractive index in a plane parallel to a surface of the sub-compensation film. The maximum in-plane refractive indices of the plurality of sub-compensation films 151 are all equal, the minimum in-plane refractive indices of the plurality of sub-compensation films 151 are all equal, a direction where the maximum in-plane refractive index of the sub-compensation film 151 lies is a maximum in-plane refractive index direction, the plurality of sub-compensation films 151 include N sub-compensation films whose maximum in-plane refractive index directions are all different, and an included angle between the maximum in-plane refractive index directions of different sub-compensation films in the N sub-compensation films is substantially an integer multiple of 360 degrees/2N, and the included angle is not greater than 90 degrees.

It should be noted that FIG. 5 schematically illustrates a partially enlarged schematic diagram of FIG. 2 at position A, and only illustrates the structure of the compensation film 150, without relating to the shape of the film layer, and it should be understood that the structure of the compensation film 150 at other positions is the same as that in FIG. 5.

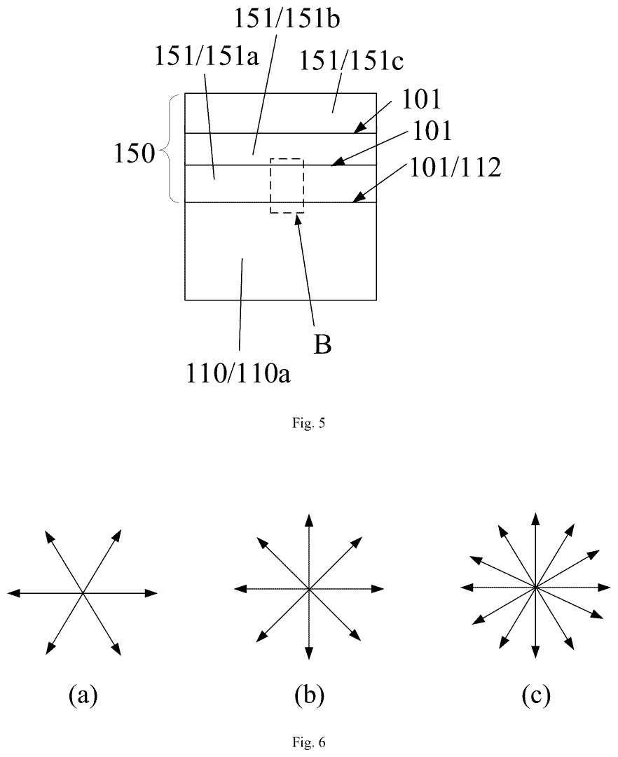

FIG. 6 is an equivalent schematic diagram of maximum in-plane refractive index directions of a plurality of sub-compensation films of a compensation film provided in embodiments of the present disclosure. A double-arrowed straight line in FIG. 6 represents the maximum in-plane refractive index direction, and the plurality of maximum in-plane refractive index directions pass through a same point to more clearly show the relationship between the plurality of maximum in-plane refractive index directions, rather than serving as a limitation of the embodiments of the present disclosure. As illustrated by FIG. 5 and (a) of FIG. 6, the compensation film 150 includes 3 sub-compensation films 151. For example, the maximum in-plane refractive index directions of the 3 sub-compensation films 151 are all different, and the included angle between the maximum in-plane refractive index directions of any two sub-compensation films of the 3 sub-compensation films 151 is roughly 60 degrees. For example, the included angle is in a range of 50 degrees to 70 degrees.

For example, as illustrated by (b) of FIG. 6, the compensation film includes four sub-compensation films whose maximum in-plane refractive index directions are all different, and the included angle between the maximum in-plane refractive index directions of any two sub-compensation films is substantially the integer multiple of 45 degrees, for example, the included angle is substantially 45 degrees or 90 degrees. For example, when the maximum in-plane refractive index directions of the four sub-compensation films pass through the same point, the maximum in-plane refractive index directions of the four sub-compensation films are approximately centrosymmetric about the point.

For example, as illustrated by (c) of FIG. 6, the compensation film includes six sub-compensation films whose maximum in-plane refractive index directions are all different, and the included angle between the maximum in-plane refractive index directions of any two sub-compensation films is substantially the integer multiple of 30 degrees, for example, the included angle is substantially 30 degrees, 60 degrees, or 90 degrees. For example, when the maximum in-plane refractive index directions of the six sub-compensation films pass through the same point, the maximum in-plane refractive index directions of the six sub-compensation films are substantially centrosymmetric about the point. Of course, the number of sub-compensation films included in the compensation film is not limited in the embodiments of the present disclosure, for example, the number may be 2, 5, 7, etc., and will not be repeated redundantly herein.

In the present example, although the in-plane phase retardation of each sub-compensation film is not zero, however, the included angle of different maximum in-plane refractive index directions of the plurality of sub-compensation films are approximately integer multiples of 360 degrees/2N, such that the maximum in-plane refractive indices in different directions of the compensation film are approximately the same. Therefore, the in-plane phase retardations of the plurality of sub-compensation films can be approximately cancelled out, then the in-plane phase retardation of the compensation film is approximately zero, and the influence of the in-plane phase retardation of the compensation film on imaging is reduced as much as possible. Moreover, each sub-compensation film includes a plurality of protruding structures spaced apart, and the phase retardation in the thickness direction of each sub-compensation film is a negative value, therefore, the phase retardation in the thickness direction of the compensation film is also a negative value, and the compensation film can compensate the optical film layer or the optical component having the positive phase retardation in the thickness direction. In the present example, the compensating effect of the compensation film can also be achieved by the plurality of sub-compensation films. Therefore, compensation films of different structures may be selected according to actual needs.

In some examples, as illustrated by FIG. 5 and FIG. 6 and with reference to the definition of the filling rate of the protruding structures through which the reference line passes in FIG. 4, in the section of each sub-compensation film 151 of the N sub-compensation films, the filling rate of the protruding structures through which the reference line extending along the maximum in-plane refractive index direction passes is greater than the filling rate of the protruding structures through which the reference line extending along the other directions passes. Therefore, the sub-compensation film 151 has the maximum in-plane refractive index.

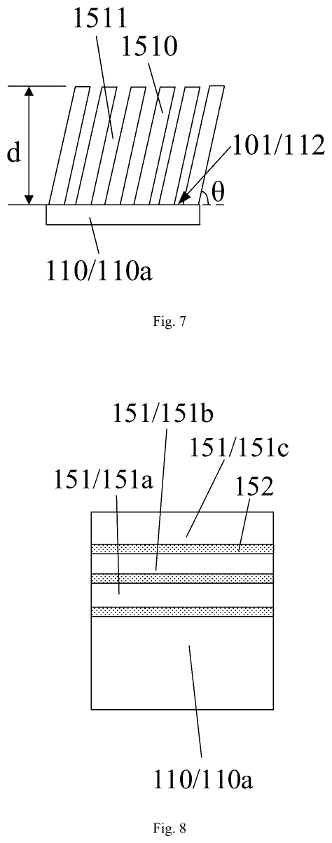

FIG. 7 is a schematic diagram of a local region B of a sub-compensation film of FIG. 5. As illustrated by FIG. 5 and FIG. 7, a plurality of protruding structures 1510 of each sub-compensation film 151 is arranged on the setting surface 101 in an inclined manner, i.e., an included angle between the protruding structure 1510 of each sub-compensation film 151 and a normal line of the setting surface 101 at the protruding structure 1510 is greater than zero. For example, the setting surface 101 of the sub-compensation film 151a is the surface of the lens structure 110, of course, the setting surface 101 of the sub-compensation film 151a is not limited in the embodiments of the present disclosure, and may also be the surface of the film material, for example, the film material includes, but is not limited to, the reflective polarizing film and the phase retardation film. For example, the setting surface 101 of the sub-compensation film 151b is a surface of the sub-compensation film 151a. For example, the setting surface 101 of the sub-compensation film 151c is a surface of the sub-compensation film 151b.

In the present example, when the protruding structure 1510 is arranged on the setting surface 101 in the inclined manner, the sub-compensation film 151 can have the maximum in-plane refractive index and the minimum in-plane refractive index, and the maximum in-plane refractive index and the minimum in-plane refractive index are not equal. For example, the included angle θ between the protruding structure 1510 and the setting surface 101 is not greater than 80 degrees. For example, the included angle θ is not greater than 70 degrees. For example, the included angle θ is not greater than 60 degrees. The value of the included angle is not limited in the embodiments of the present disclosure.

FIG. 7 only schematically shows a schematic diagram of the local structure of one sub-compensation film 151 at position B. The plurality of protruding structures 1510 of other sub-compensation films 151 are also arranged on the corresponding setting surfaces 101 in the inclined manner, which will not be repeated redundantly herein. For example, inclined directions of the protruding structures 1510 of different sub-compensation films 151 are not the same.

For example, the included angles between the plurality of protruding structures of each sub-compensation film and the setting surface are not the same. For example, the included angles between the plurality of protruding structures of each sub-compensation film and the setting surface may be partially the same. For example, the plurality of protruding structures of each sub-compensation film may be partially parallel. For example, the plurality of protruding structures of each sub-compensation film may be arranged in parallel.

For example, as illustrated by FIG. 7, the inclined angles of the plurality of protruding structures 1510 of the same sub-compensation film 151 are substantially the same. For example, the inclined directions of the plurality of protruding structures 1510 of the same sub-compensation film 151 are substantially the same.

For example, the sub-compensation film may be formed using the glancing-angle deposition (GLAD) method, such that the protruding structure of the sub-compensation film is arranged on the setting surface in the inclined manner, which is of course not defined in the embodiments of the present disclosure, for example, the sub-compensation film may also be formed using the physical vapor deposition (PVD), chemical vapor deposition (CVD), or glancing-angle deposition (GLAD) method.

In some examples, as illustrated by FIG. 5, thicknesses of the plurality of sub-compensation films 151 are all the same. Therefore, the in-plane phase retardation of the compensation film 150 may be closer to 0, thereby further reducing the influence of the optical structure 100 on imaging. Referring to FIG. 7, the thickness d of the sub-compensation film 151 is a vertical distance from the end face, away from the setting surface 101, of the protruding structure 151 to the setting surface 101.

In some examples, dimensions of the plurality of protruding structures in the thickness direction of the sub-compensation film is in a range of 100 nm to 5 μm. For example, the dimension may be 300 nm, 500 nm, 800 nm, 1 μm, 1.5 μm, 2 μm, 2.5 μm, 3 μm, 3.5 μm, 4 μm, and 4.5 μm. For example, as illustrated by FIG. 3, when the included angle between the protruding structure 1510 and the setting surface 101 is 90 degrees, the dimension is equal to the height of the protruding structure 1510. For example, as illustrated by FIG. 7, when the included angle between the protruding structure 1510 and the setting surface 101 is not equal to 90 degrees, i.e., when the protruding structure 1510 is arranged on the setting surface 101 in the inclined manner, the dimension is a vertical distance from the end face, away from the setting surface 101, of the protruding structure 1510 to the setting surface 101.

In some examples, a ratio of the dimensions of different protruding structures in the thickness direction is in a range of 0.8 to 1.2. e.g., the ratio is in a range of 0.9 to 1.1. e.g., the ratio is 1. At this time, the plurality of protruding structures have the same dimension in the thickness direction of the sub-compensation film.

In some examples, within the section, parallel to the setting surface, of the sub-compensation film, a sectional dimension of each protruding structure is in a range of 5 nm to 200 nm. For example, the sectional dimension may be 10 nm, 30 nm, 50 nm, 80 nm, 100 nm, 130 nm, 150 nm, and 180 nm.

For example, within the section, parallel to the setting surface, of the sub-compensation film, a shape of the sectional contour of each protruding structure may be rectangular, circular, elliptical, or polygonal, and the sectional contour of the protruding structure is not limited in the embodiments of the present disclosure. For example, the protruding structure may be a columnar structure.

In some examples, as illustrated by FIG. 2, the lens structure 110 includes the lens 110a, the phase retardation film 140 is arranged on a side, away from the lens 110a, of the compensation film 150, i.e., the compensation film 150 is arranged between the phase retardation film 140 and the lens structure 110, the average refractive index of the compensation film 150 is n1, the average refractive index of the phase retardation film 140 is n2, and the average refractive index of the lens 110a is n3, and n2>n1>n3. According to the foregoing, the in-plane refractive index and the refractive index in the thickness direction of the compensation film 150 can be set, and when the average refractive index n1 of the compensation film 150 can be made between the average refractive index n2 of the phase retardation film 140 and the average refractive index n3 of the lens 110a, the reflections among the three may be reduced, and the imaging quality may be improved.

For example, when the lens structure includes at least one lens, the at least one lens includes a compensation attached lens that is closest to the compensation film, the phase retardation film is arranged on a side, away from the compensation attached lens, of the compensation film, the compensation film is arranged between the phase retardation film and the compensation attached lens, and the average refractive index of the compensation film is n1, the average refractive index of the phase retardation film is n2, the average refractive index of the compensation attached lens is n3, and n2≥n1≥n3. In some examples, as illustrated by FIG. 2, the lens 110a is the compensation attached lens.

In some examples, the compensation film may also be arranged between the phase retardation film and the reflective polarizing film, the reflective polarizing film includes a transmission axis and a reflection axis, the refractive index of the reflective polarizing film in a transmission axis direction is n4, the average refractive index of the phase retardation film is n2, and the average refractive index of the compensation film is n1, and the value of n1 is between the value of n4 and the value of n2, thereby reducing reflections between the phase retardation film, the compensation film and the reflective polarizing film.

In some examples, the phase retardation in the thickness direction of the compensation film is in a range of −20 nm to −130 nm. The value of the phase retardation is not limited in the embodiments of the present disclosure, and may be set according to the phase retardation that needs to be compensated. For example, the phase retardation in the thickness direction of the compensation film may be −20 nm, −30 nm, −40 nm, −50 nm, −60 nm, −70 nm, −80 nm, −90 nm, −100 nm, −110 nm, −120 nm, −130 nm, and the like.

In some examples, the materials of the compensation film include at least one of the group consisting of titanium dioxide (TiO₂), zirconium dioxide (ZrO₂), aluminum oxide (Al₂O₃), niobium pentoxide (Nb₂O₅), tantalum pentoxide (Ta₂O₅), cerium dioxide (CeO₂), hafnium dioxide (HfO₂), magnesium oxide (MgO), zinc oxide (ZnO), silicon dioxide (SiO₂), silicon monoxide (SiO), yttrium trioxide (Y₂O₃), yttrium trifluoride (YF₃), lanthanum trifluoride (LaF₃), magnesium difluoride (MgF₂), silicon nitride (Si₃N₄), zinc sulphide (ZnS), lanthanum titanate (LaTiO₃), and other pure substances, mixtures, and polymer compounds of such transparent inorganic media. For example, the material of the compensation film may also be an organic material, for example, the compensation film may be at least one of the group consisting of acrylic resin, polyolefin, polysiloxane, and polycarbonate.

In some examples, as illustrated by FIG. 3 and FIG. 7, the sub-compensation film 151 further includes a filling medium 1511 arranged between the plurality of protruding structures 1510 which are spaced apart, and the refractive index of the filling medium 1511 is less than the refractive index of the material of the protruding structures 1510. For example, the filling medium may be an optical adhesive or air. Of course, the material of the optical medium is not limited in the embodiments of the present disclosure.

In some examples, as illustrated by FIG. 2, the optical structure 100 further includes a linear polarizing film 160 and an anti-reflective film 170, wherein the linear polarizing film 160 is arranged on a side, away from the lens structure 110, of the reflective polarizing film 130, and the anti-reflective film 170 is arranged on a side, away from the lens structure 110, of the linear polarizing film 160. The linear polarizing film 160 and the anti-reflective film 170 can reduce reflections of the reflective polarizing film 130 adjacent to the light-exiting side S2, thereby making the optical structure 100 have a better display effect.

In some examples, the beam splitting film of the optical structure may be a visible light wide-field depolarizing beam splitting film having broadband beam splitting properties. For example, a reflectance and transmittance of the beam splitting film are equal and are close to 50%. Of course, a material of the beam splitting film is not limited in the embodiments of the present disclosure.

For example, the beam splitting film may be arranged on a surface of the lens structure between the beam splitting film and the reflective polarizing film. For example, the beam splitting film may be arranged on a surface, adjacent to the reflective polarizing film, of the lens. For example, the beam splitting film may be arranged on a surface, adjacent to the beam splitting film, of the reflective polarizing film.

In some examples, as illustrated by FIG. 2, the compensation film 150 is arranged on the second surface 112 of the lens structure 110, and the phase retardation film 140 is arranged on a surface, away from the second surface 112, of the compensation film 150, and the second surface 112 is the setting surface 101. The phase retardation film 140 is directly arranged on the surface of the compensation film 150, the compensation film 150 is adjacent to the phase retardation film 140, and the compensation film 150 may better play a role in compensation.

For example, as illustrated by FIG. 2, the second surface 112 is a curved surface, which is not limited in the embodiments of the present disclosure, and the second surface 112 may also be a plane surface.

FIG. 8 is an enlarged schematic diagram of a local region A of still another compensation film illustrated by FIG. 2. As illustrated by FIG. 8, an adhesion-increasing film 152 is further arranged between the sub-compensation film 151a and the lens 110, therefore, the adhesion-increasing film 152 can improve an adhesive force between the plurality of protruding structures 1510 of the sub-compensation film 151a and the surface of the lens 110a, so as to improve stability.

For example, as illustrated by FIG. 8, the compensation film 150 includes a plurality of sub-compensation films 151, and the adhesion-increasing film 152 is arranged between the plurality of sub-compensation films 151, and the adhesion-increasing film 152 can improve the adhesive force between the protruding structures 1510 of different sub-compensation films 151, so as to improve stability.

For example, the adhesion-increasing film may also be referred to as an undercoat layer or a seed layer.

For example, when the compensation film includes one sub-compensation film, the adhesion-increasing film may be formed on the surface of the lens or on the surface of the film material, and then the sub-compensation film may be formed on the adhesion-increasing film. For example, when the compensation film includes the plurality of sub-compensation films, after one sub-compensation film is formed, the adhesion-increasing film is first formed on the sub-compensation film, and then another sub-compensation film is formed on the adhesion-increasing film. In the above case, the surface of the film material on which the sub-compensation film is located includes the surface of the adhesion-increasing film.

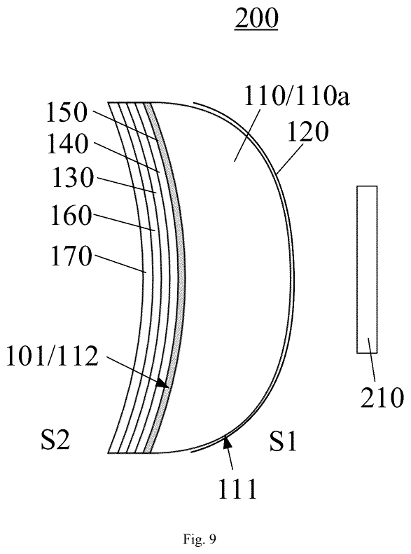

Embodiments of the present disclosure further provide a display apparatus. FIG. 9 is a sectional schematic diaphragm of a display apparatus provided in the embodiments of the present disclosure. As illustrated by FIG. 9, the display apparatus 200 includes a display screen 210 and any of the preceding optical structures 100, and the display screen 210 is arranged on the light incident side S1 of the optical structure 100. Therefore, the display apparatus 200 has the beneficial effects corresponding to the beneficial effects of the optical structure 100, which will not be repeated redundantly herein.

For example, the display apparatus 200 may be a virtual reality (VR) or mixed reality (MR) near-eye display apparatus 200.

The following several points need to be noted.

(1) The accompanying drawings of the embodiments of the present disclosure relate only to structures involved in the embodiments of the present disclosure, and for other structures, reference may be made to general designs.

(2) The features in the same embodiment and in different embodiments of the present disclosure may be combined with each other without conflict.

The foregoing descriptions are merely specific implementations of the present disclosure, but are not intended to limit the scope of protection of the present disclosure. Any variation or replacement readily figured out by those skilled in the art within the technical scope disclosed in the present disclosure shall fall within the scope of protection of the present disclosure. Therefore, the scope of protection of the present disclosure shall be subject to the scope of protection of the claims.

1. An optical structure, having a light incident side and a light-exiting side, comprising:
a lens structure, comprising a first surface and a second surface arranged opposite to each other, wherein the first surface is a surface of the lens structure on the light incident side;
a beam splitting film, arranged on a side, away from the second surface, of the first surface;
a reflective polarizing film, arranged on a side, away from the first surface, of the second surface;
a phase retardation film, arranged between the beam splitting film and the reflective polarizing film; and
a compensation film, arranged between the beam splitting film and the reflective polarizing film,
wherein the compensation film comprises at least one sub-compensation film, and each of the at least one sub-compensation film comprises a plurality of protruding structures spaced apart,
a refractive index of the compensation film in a thickness direction is nz, the compensation film has a maximum in-plane refractive index and a minimum in-plane refractive index in a plane parallel to a surface of the compensation film, the maximum in-plane refractive index and the minimum in-plane refractive index are nx and ny, respectively, and a thickness of the compensation film is d, and nz, nx, ny, and d satisfy a following relational equation:
$$nz > nx , nz > ny ;$$
$$( nx - ny ) * d \leq 20 nm .$$

2. The optical structure according to claim 1, wherein the at least one sub-compensation film comprises one sub-compensation film,
within a section, parallel to a setting surface, of the one sub-compensation film, a total length of protruding structures of the plurality of protruding structures of the one sub-compensation film through which one same reference line passes is L1, and a length of the same reference line between two points where the same reference line intersects an outer contour of the one sub-compensation film is L2, and a ratio of L1 to L2 is a filling rate of the protruding structures of the plurality of protruding structures through which the reference line passes, the setting surface is a surface of the lens structure or a surface of a film material on which the one sub-compensation film is located, and an orthographic projection of the reference line on a plane vertical to an optical axis of the lens structure is a straight line, and
within the section, an absolute value of a difference of the filling rates of the protruding structures through which different reference lines pass is not greater than 30%.

3. The optical structure according to claim 2, wherein an average value of included angles between the plurality of protruding structures and the setting surface is in a range of 80 degrees to 90 degrees.

4. The optical structure according to claim 2, wherein, within the section, a length of a line segment passing through a sectional centre of the protruding structure of the plurality of protruding structures and intersecting with a sectional contour of the protruding structure of the plurality of protruding structures is a sectional dimension, the protruding structure of the plurality of protruding structures has a maximum sectional dimension and a minimum sectional dimension, and a ratio of the maximum sectional dimension to the minimum sectional dimension is not greater than 5.

5. The optical structure according to claim 2, wherein a ratio of refractive indices of the one sub-compensation film in directions of the different reference lines is in a range of 0.7 to 1.3.

6. The optical structure according to claim 1, wherein the at least one sub-compensation film comprises a plurality of sub-compensation films arranged in a stacking manner, each of the plurality of sub-compensation films has a maximum in-plane refractive index and a minimum in-plane refractive index in a plane parallel to a surface thereof, the maximum in-plane refractive indices of the plurality of sub-compensation films are all equal, the minimum in-plane refractive indices of the plurality of sub-compensation films are all equal, and a direction where the maximum in-plane refractive index of each of the plurality of sub-compensation films lies is a maximum in-plane refractive index direction, and
the plurality of sub-compensation films comprise N sub-compensation films whose maximum in-plane refractive index directions are all different, and an included angle between the maximum in-plane refractive index directions of different sub-compensation films in the N sub-compensation films is substantially an integer multiple of 360 degrees/2N, and the included angle is not greater than 90 degrees.

7. The optical structure according to claim 6, wherein, within a section, parallel to a setting surface, of each sub-compensation film of the N sub-compensation films, a total length of protruding structures of the plurality of protruding structures of the sub-compensation film of the N sub-compensation films through which one same reference line passes is L1, and a length of the same reference line between two points where the same reference line intersects an outer contour of the sub-compensation film of the N sub-compensation films is L2, and a ratio of LI to L2 is a filling rate of the protruding structures of the plurality of protruding structures through which the reference line passes, the setting surface is a surface of the lens structure or a surface of a film material on which the sub-compensation film of the N sub-compensation films is located, and an orthographic projection of the reference line on a plane vertical to an optical axis of the lens structure is a straight line, and
within the section, the filling rate of the protruding structures of the plurality of protruding structures through which the reference line extending along the maximum in-plane refractive index direction passes is greater than the filling rate of the protruding structures of the plurality of protruding structures through which the reference line extending in other directions passes.

8. The optical structure according to claim 7, wherein the plurality of protruding structures of each of the N sub-compensation films is arranged on the setting surface in an inclined manner.

9. The optical structure according to claim 1, wherein, in the thickness direction of the sub-compensation film, dimensions of the plurality of protruding structures are in a range of 100 nm to 5 μm, and a ratio of the dimensions of different protruding structures of the plurality of protruding structures in the thickness direction is in a range of 0.8 to 1.2; and
within a section, parallel to the setting surface, of the sub-compensation film of the at least one sub-compensation film, a length of a line segment passing through a sectional centre of the protruding structure of the plurality of protruding structures and intersecting with an sectional contour of the protruding structure of the plurality of protruding structures is a sectional dimension, the sectional dimension is in a range of 5 nm to 200 nm, and the setting surface is a surface of the lens structure or a surface of a film material on which the sub-compensation film of the at least one sub-compensation film is located.

10. The optical structure according to claim 1, wherein the lens structure comprises at least one lens, the at least one lens comprises a compensation attached lens that is closest to the compensation film, the phase retardation film is arranged on a side, away from the compensation attached lens, of the compensation film, an average refractive index of the compensation film is n1, an average refractive index of the phase retardation film is n2, an average refractive index of the compensation attached lens is n3, and n2≥ n1≥n3.

11. The optical structure according to claim 1, wherein a phase retardation Rth in the thickness direction of the compensation film satisfies a following formula: Rth=[(nx+ny)/2−nz]*d, and the phase retardation Rth in the thickness direction of the compensation film is in a range of −20 nm to −130 nm.

12. The optical structure according to claim 1, wherein the lens structure comprises at least one lens, the compensation film is arranged on a surface of a lens of the at least one lens, the phase retardation film is arranged on a surface, away from the lens, of the compensation film, and the surface of the lens is a setting surface.

13. The optical structure according to claim 1, wherein the second surface comprises at least one of the group consisting of a plane surface and a curved surface.

14. The optical structure according to claim 1, wherein a material of the compensation film comprises at least one of the group consisting of titanium dioxide, zirconium dioxide, aluminum oxide, niobium pentoxide, tantalum pentoxide, cerium dioxide, hafnium dioxide, magnesium oxide, zinc oxide, silicon dioxide, silicon monoxide, yttrium trioxide, yttrium trifluoride, lanthanum trifluoride, magnesium difluoride, silicon nitride, zinc sulfide, lanthanum titanate, acrylic resin, polyolefin, polysiloxane, and polycarbonate.

15. The optical structure according to claim 1, wherein the sub-compensation film further comprises a filling medium arranged between the plurality of protruding structures spaced apart, and a refractive index of the filling medium is less than a refractive index of a material of the protruding structure of the plurality of protruding structures.

16. The optical structure according to claim 1, further comprising:
a linear polarizing film, arranged on a side, away from the lens structure, of the reflective polarizing film; and
an anti-reflective film, arranged on a side, away from the lens structure, of the linear polarizing film.

17. A display device, comprising a display screen and an optical structure, wherein the optical structure has a light incident side and a light-exiting side, the display screen is arranged on the light incident side of the optical structure,
the optical structure comprises:
a lens structure, comprising a first surface and a second surface arranged opposite to each other, wherein the first surface is a surface of the lens structure on the light incident side;
a beam splitting film, arranged on a side, away from the second surface, of the first surface;
a reflective polarizing film, arranged on a side, away from the first surface, of the second surface;
a phase retardation film, arranged between the beam splitting film and the reflective polarizing film; and
a compensation film, arranged between the beam splitting film and the reflective polarizing film,
wherein the compensation film comprises at least one sub-compensation film, and each of the at least one sub-compensation film comprises a plurality of protruding structures spaced apart,
a refractive index of the compensation film in a thickness direction is nz, the compensation film has a maximum in-plane refractive index and a minimum in-plane refractive index in a plane parallel to a surface of the compensation film, the maximum in-plane refractive index and the minimum in-plane refractive index are nx and ny, respectively, and a thickness of the compensation film is d, and nz, nx, ny, and d satisfy a following relational equation:
$$nz > nx , nz > ny ;$$
$$( nx - ny ) * d \leq 20 nm .$$

18. The display device according to claim 17, wherein the at least one sub-compensation film comprises one sub-compensation film,
within a section, parallel to a setting surface, of the one sub-compensation film, a total length of protruding structures of the plurality of protruding structures of the one sub-compensation film through which one same reference line passes is L1, and a length of the same reference line between two points where the same reference line intersects an outer contour of the one sub-compensation film is L2, and a ratio of L1 to L2 is a filling rate of the protruding structures of the plurality of protruding structures through which the reference line passes, the setting surface is a surface of the lens structure or a surface of a film material on which the one sub-compensation film is located, and an orthographic projection of the reference line on a plane vertical to an optical axis of the lens structure is a straight line, and
within the section, an absolute value of a difference of the filling rates of the protruding structures through which different reference lines pass is not greater than 30%.

19. The display device according to claim 17, wherein the at least one sub-compensation film comprises a plurality of sub-compensation films arranged in a stacking manner, each of the plurality of sub-compensation films has a maximum in-plane refractive index and a minimum in-plane refractive index in a plane parallel to a surface thereof, the maximum in-plane refractive indices of the plurality of sub-compensation films are all equal, the minimum in-plane refractive indices of the plurality of sub-compensation films are all equal, and a direction where the maximum in-plane refractive index of each of the plurality of sub-compensation films lies is a maximum in-plane refractive index direction, and
the plurality of sub-compensation films comprise N sub-compensation films whose maximum in-plane refractive index directions are all different, and an included angle between the maximum in-plane refractive index directions of different sub-compensation films in the N sub-compensation films is substantially an integer multiple of 360 degrees/2N, and the included angle is not greater than 90 degrees.

20. The display device according to claim 17, wherein the lens structure comprises at least one lens, the at least one lens comprises a compensation attached lens that is closest to the compensation film, the phase retardation film is arranged on a side, away from the compensation attached lens, of the compensation film, an average refractive index of the compensation film is n1, an average refractive index of the phase retardation film is n2, an average refractive index of the compensation attached lens is n3, and n2≥n1≥n3.
